(19) United States
(12) Patent Application Publication
(10) Pub. No.: US 2007/0028301 A1
(43) Pub. Date: Feb. 1, 2007

(54) ENHANCED FRAUD MONITORING SYSTEMS

(75) Inventors: Mark Shull, Chevy Chase, MD (US); Ihab Shraim, Germantown, MD (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MarkMonitor Inc., Boise, ID (US)

(21) Appl. No.: 11/428,072

(22) Filed: Jun. 30, 2006

Related U.S. Application Data
(60) Provisional application No. 60/696,006, filed on Jul. 1, 2005.

(51) Int. Cl. G06F 12/14

(52) U.S. Cl. 726/22

(57) ABSTRACT

Various embodiments of the invention provide systems and methods for the enhanced detection and/or prevention of fraud. A set of embodiments provides, for example, a facility where companies (online businesses, banks, ISPs, etc.) provide a security provider with fraud feeds (such as, to name one example, a feed of email messages from third parties addressed to customers of those businesses), as well as systems and methods of implementing such a facility. In some embodiments, feeds (such as messages) may be analyzed to create normalized direct and/or derived data which then may be made available to such companies (perhaps for a fee). By defining and controlling access to the direct and derived data, a security provider may enable such companies to negotiate bilateral and other agreements between themselves as to who they will exchange data with, what data will be exchanged, and under what commercial and other terms such data will be exchanged.

### CROSS-REFERENCES TO RELATED APPLICATIONS

This application claims priority from U.S. Provisional Patent Application No. 60/696,006 filed Jul. 1, 2005 entitled “Enhanced Fraud Monitoring Systems” which is herein incorporated by reference, as if set forth in full in this document, for all purposes.

This application is related to the following commonly-owned, copending applications (the “Related Applications”), of which the entire disclosure of each is incorporated herein by reference, as if set forth in full in this document, for all purposes:

U.S. patent application Ser. No. 10/709,398 filed May 2, 2004 by Shraim et al. and entitled “Online Fraud Solution”; U.S. Prov. App. Ser. No. 60/615,973, filed Oct. 4, 2004 by Shraim et al. and entitled “Online Fraud Solution”; U.S. Prov. App. Ser. No. 60/610,716, filed Sep. 17, 2004 by Shull and entitled “Methods and Systems for Preventing Online Fraud”; U.S. Prov. App. Ser. No., 60, 610,715, filed Sep. 17, 2004 by Shull et al. and entitled “Customer-Based Detection of Online Fraud”; U.S. patent application Ser. No. 10/996,991, filed Nov. 23, 2004 by Shraim et al. and entitled “Online Fraud Solution”; U.S. patent application Ser. No. 10/996,567, filed Nov. 23, 2004 by Shraim et al. and entitled “Enhanced Responses to Online Fraud”; U.S. patent application Ser. No. 10/996,990, filed Nov. 23, 2004 by Shraim et al. and entitled “Customer-Based Detection of Online Fraud”; U.S. patent application Ser. No. 10/996,566, filed Nov. 23, 2004 by Shraim et al. and entitled “Early Detection and Monitoring of Online Fraud”; U.S. patent application Ser. No. 10/996,646, filed Nov. 23, 2004 by Shraim et al. and entitled “Enhanced Responses to Online Fraud”; U.S. patent application Ser. No. 10/996,568, filed Nov. 23, 2004 by Shraim et al. and entitled “Generating Phish Messages”; U.S. patent application Ser. No. 10/997,626, filed Nov. 23, 2004 by Shraim et al. and entitled “Methods and Systems for Analyzing Data Related to Possible Online Fraud”; U.S. Prov. App. Ser. No. 60/658,124, filed Mar. 2, 2005 by Shull et al. and entitled “Distribution of Trust Data”; U.S. Prov. App. Ser. No. 60/658,087, filed Mar. 2, 2005 by Shull et al. and, entitled “Trust Evaluation System and Methods”; and U.S. Prov. App. Ser. No. 60/658,281, filed Mar. 2, 2005 by Shull et al. and entitled “Implementing Trust Policies.”

### BACKGROUND OF THE INVENTION

The problem of online fraud, including without limitation the technique of “phishing,” and other illegitimate online activities, have become a common problem for Internet users and those who wish to do business with them. Recently, many online businesses, including in particular Internet Service Providers (“ISPs”), have begun trying to track and/or combat such practices. The Related Applications cited above describe several systems and methods for detecting, preventing, and otherwise dealing with such activities.

In the past, however, each business typically has attempted to combat online fraud using its own systems and/or methods. Nonetheless, as the number and type of security threats—viruses, spyware, spam, phishing, etc.—grows in the Internet and in other networked environments, there is an increasing interest among ISPs and others to exchange and to share pertinent fraud, security, and other operational information.

Recently, several proposals have been tendered to allow for collective fraud detection and/or response, including a number of attempts to create a clearing house where participants can submit, obtain and share data, such as the Anti-Phishing Working Group and Digital Phish Net. However, these groups have had limited success for several reasons.

For example, the data they obtain and create is submitted by anyone in any format, is not normalized, does not abide by any standards or definitions, is not processed or stored uniformly and is not subject to any controls, industry or peer reviews. In other words, it does not meet sufficient standards or controls to be useful for its intended purposes. Moreover, such data is not trusted or valued by the largest companies such as ISPs, banks, auction services, etc. As a result, they do not participate in a meaningful way or at all. Furthermore, they do not contribute the large amounts of fraud and security source data they generate from their own operations and businesses.

Further, the “open” nature of these models means that anyone can contribute and a) anyone who pays a nominal fee receives the processed data or b) the data is used to drive one specific product which, in most cases, competes with the major sources of the input data. Therefore, those companies that have the most raw data, i.e., ISPs, banks, etc., are reluctant to submit data, as they see themselves as becoming the primary source for fraud detection data while others, particularly small companies who contribute little, get the primary or a disproportionate and in the eyes of the largest players, an unjustified windfall, benefit of the shared data.

### BRIEF SUMMARY OF THE INVENTION

Embodiments of the invention provide systems and methods for the enhanced detection and/or prevention of fraud. According to one embodiment, a method for providing enhanced fraud monitoring can comprise receiving from a first entity direct information related to fraudulent online activity. The direct information can be analyzed and a set of normalized data related to the fraudulent online activity can be created. Analyzing the direct information can comprise generating a set of derived information related to the fraudulent online activity. Generating the set of derived information related to the fraudulent online activity can be based on the direct information and previously saved information related to other fraudulent online activity. Such saved information can comprise direct information and derived information. The set of normalized data can be in a form readable by a plurality of entities and can include the direct information and the derived information. The set of normalized data can be stored.

The method can further comprise receiving from a second entity of the plurality of entities a request to access the stored normalized data. Access to the stored normalized data by the second entity can be controlled. For example, controlling access to the stored normalized data by the second entity can be based on an agreement between the first entity and the second entity. If permitted, at least a portion of the stored normalized data can be provided to the second entity.

According to one embodiment, receiving the direct information from the first entity can comprise receiving the direct information via an Application Program Interface (API). Additionally or alternatively, receiving the request to access the stored normalized data can comprise receiving the request via the API. In some cases, the stored normalized data can be maintained by the first entity. In such a case, the API can provide functions for the second entity to request the stored normalized data from the first entity. Additionally or alternatively, the stored normalized data can be maintained by a security service. In such a case, the API can provide functions for the first entity to provide the direct information to the security service and for the second entity to request the stored normalized data from the security service.

In some cases, the API can provide for receiving the direct information, analyzing the direct information, creating the set of normalized data, and accessing the stored normalized data through a plurality of data attributes. Additionally or alternatively, the data attributes can comprise entity specific attributes specific to either the first entity or the second entity and/or shared attributes that can be shared between the first entity and the second entity based on permissions established by the first entity and the second entity. The API can further comprise a schema defining the data attributes. The schema can comprise, for example, an extensible Markup Language (XML) schema. The schema can, in some cases, further comprise metadata tagged to the data attributes. In such a case, the metadata can track the data attributes to which it is tagged.

According to yet another embodiment, a machine-readable medium can have stored thereon a series of instruction which, when executed by a processor, cause the processor to provide enhanced fraud monitoring by receiving from a first entity direct information related to fraudulent online activity. The direct information can be analyzed and a set of normalized data related to the fraudulent online activity can be created. Analyzing the direct information can comprise generating a set of derived information related to the fraudulent online activity. Generating the set of derived information related to the fraudulent online activity can be based on the direct information and previously saved information related to other fraudulent online activity. Such saved information can comprise direct information and derived information. The set of normalized data can be in a form readable by a plurality of entities and can include the direct information and the derived information. The set of normalized data can be stored.

According to still another embodiment, a system for providing enhanced fraud monitoring can comprise a communication network and a first client communicatively coupled with the communication network. The first client can be adapted to provide direct information related to fraudulent online activity. The system can also include a server communicatively coupled with the communication network. The server can be adapted to receive from the first client direct information related to fraudulent online activity, analyze the direct information, create a set of normalized data related to the fraudulent online activity, wherein the set of normalized data is in a form readable by a plurality of clients, and store the set of normalized data.

The server can be further adapted to generate a set of derived information related to the fraudulent online activity. For example, the server can be adapted to generate the set of derived information related to the fraudulent online activity based on the direct information and previously saved information related to other fraudulent online activity. Such saved information can comprise direct information and derived information. The set of normalized data created by the server can include the direct information and the derived information.

The system can also include a second client. In such a case, the server can be further adapted to receive from the second client a request to access the stored normalized data and control access to the stored normalized data by the second client. For example, the server can be adapted to control access to the stored normalized data by the second client based on an agreement between the first client and the second client. If permissible, the server can provide at least a portion of the stored normalized data to the second client.

According to one embodiment, the server can be adapted to receive the direct information from the first client via an Application Program Interface (API). Additionally or alternatively, the server can receive the request to access the stored normalized data via the API. The API can provide for receiving the direct information, analyzing the direct information, creating the set of normalized data, and accessing the stored normalized data through a plurality of data attributes. The data attributes can comprise entity specific attributes specific to either the first client or the second client and/or shared attributes that can be shared between the first client and the second client based on permissions established by the first client and the second client.

According to still another embodiment, a system for providing enhanced fraud monitoring can comprise a communication network and a first client communicatively coupled with the communication network. The first client can be adapted to generate direct information related to fraudulent online activity, analyze the direct information, create a set of normalized data related to the fraudulent online activity, wherein the set of normalized data is in a form readable by a plurality of clients, and store the set of normalized data. The system can also include a second client communicatively coupled with the communication network. The second client can be adapted to request to access stored the stored normalized data. A server can be communicatively coupled with the communication network and can be adapted to receive from the second a request to access the stored normalized data and control access to the stored normalized data by the second client. The server can be adapted to control access to the stored normalized data by the second client based on an agreement between the first client and the second client. If permissible, the first client can provide at least a portion of the stored normalized data to the second client.

According to one embodiment, the server can be adapted to receive the request to access the stored normalized data from the second client by receiving the request via an Application Program Interface (API). The API can provide for accessing the stored normalized data through a plurality of data attributes. The data attributes can comprise client specific attributes specific to either the first client or the second client and/or shared attributes that can be shared between the first client and the second client based on permissions established by the first client and the second client.

### BRIEF DESCRIPTION OF THE DRAWINGS

FIG. 1A is a functional diagram illustrating a system for combating online fraud, in accordance with various embodiments of the invention.

FIG. 1B is a functional diagram illustrating a system for planting bait email addresses, in accordance with various embodiments of the invention.

FIG. 2 is a schematic diagram illustrating a system for combating online fraud, in accordance with various embodiments of the invention.

FIG. 3 is a generalized schematic diagram of a computer that may be implemented in a system for combating online fraud, in accordance with various embodiments of the invention.

FIG. 4 illustrates a typical relationship between a security provider and a plurality of customers of the security provider.

FIG. 5 illustrates a peering relationship between a security provider and a plurality of customers of the security provider, in accordance with embodiments of the invention.

FIG. 6 illustrates a private peering application programming interface, in accordance with some embodiments of the invention.

FIG. 7 is a flowchart illustrating a process for collecting information to provide enhanced fraud monitoring according to one embodiment of the present invention.

FIG. 8 is a flowchart illustrating a process for providing information related to enhanced fraud monitoring according to one embodiment of the present invention.

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Various embodiments of the invention provide systems and methods for the enhanced detection and/or prevention of fraud. A set of embodiments provides, for example, a facility where companies (online businesses, banks, ISPs, etc.) provide a security provider with fraud feeds (such as, to name one example, a feed of email messages from third parties addressed to customers of those businesses), as well as systems and methods of implementing such a facility. In some embodiments, feeds (such as messages) may be analyzed to create normalized direct and/or derived data which then may be made available to such companies (perhaps for a fee). By defining and controlling access to the direct and derived data, a security provider may enable such companies to negotiate bilateral and other agreements between themselves as to who they will exchange data with, what data will be exchanged, and under what commercial and other terms such data will be exchanged.

Hence, some embodiments of the invention provide a model to allow ISPs (and others) to set up specific bilateral rules for the exchange of fraud detection data, much along the lines of private network peering. In a set of embodiments, a security provider may provide detection systems (such as those described in the Related Applications, to cite a few examples) at key network “meet-me” centers, so it is easy and economical to exchange data.

In accordance with various embodiments, systems, methods and software are provided for combating online fraud, and specifically “phishing” operations. An exemplary phishing operation, known as a “spoofing” scam, uses “spoofed” email messages to induce unsuspecting consumers into accessing an illicit web site and providing personal information to a server believed to be operated by a trusted affiliate (such as a bank, online retailer, etc.), when in fact the server is operated by another party masquerading as the trusted affiliate in order to gain access to the consumers' personal information. As used herein, the term “personal information” should be understood to include any information that could be used to identify a person and/or normally would be revealed by that person only to a relatively trusted entity. Merely by way of example, personal information can include, without limitation, a financial institution account number, credit card number, expiration date and/or security code (sometimes referred to in the art as a “Card Verification Number,” “Card Verification Value,” “Card Verification Code” or “CVV”), and/or other financial information; a userid, password, mother's maiden name, and/or other security information; a full name, address, phone number, social security number, driver's license number, and/or other identifying information.

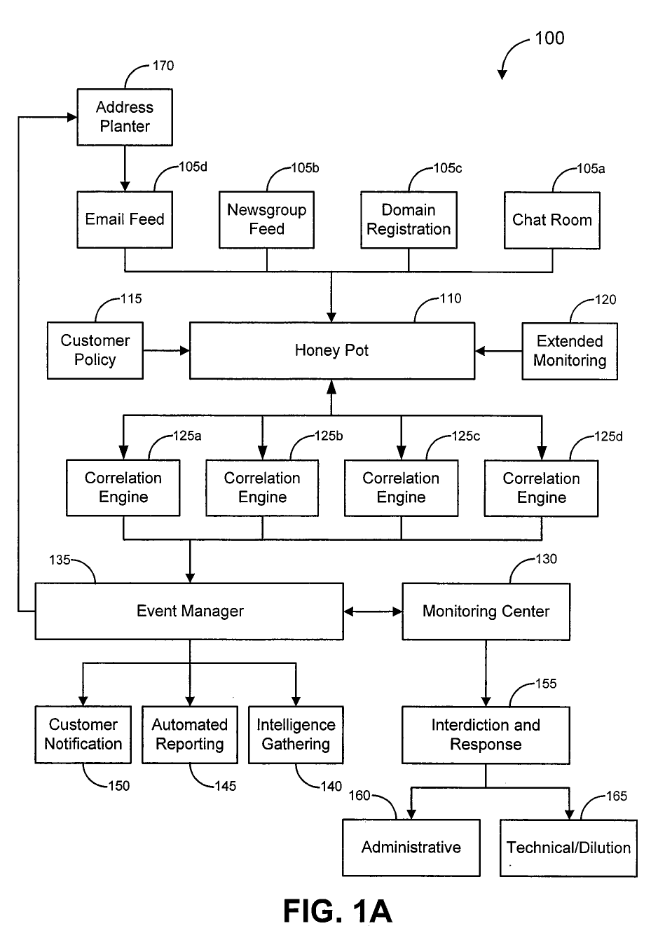

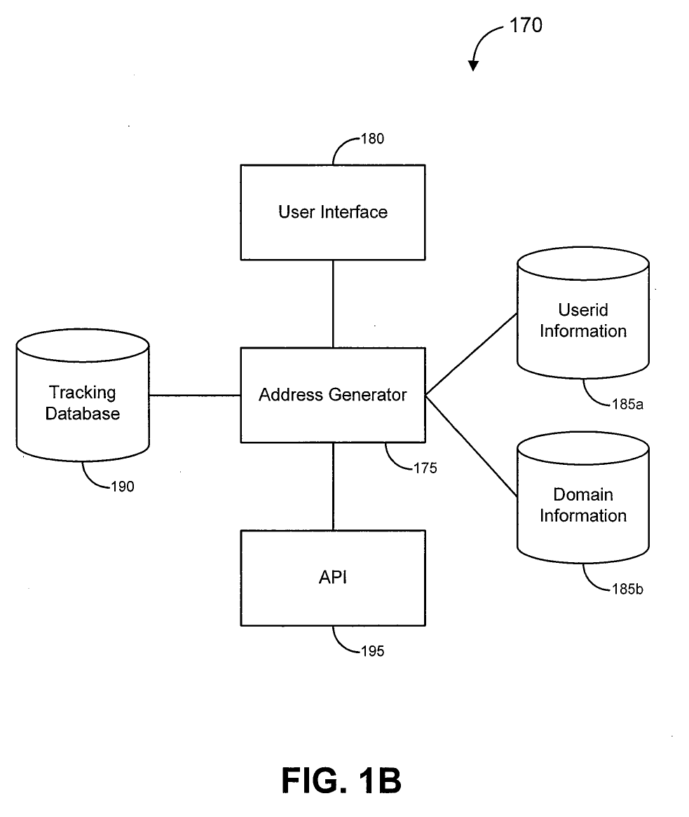

Certain embodiments of the invention feature systems, methods and/or software that attract such spoofed email messages, analyze the messages to assess the probability that the message is involved with a fraudulent activity (and/or comprises a spoofed message), and provide responses to any identified fraudulent activity. FIG. 1A illustrates the functional elements of an exemplary system 100 that can be used to combat online fraud in accordance with some of these embodiments and provides a general overview of how certain embodiments can operate. (Various embodiments will be discussed in additional detail below). It should be noted that the functional architecture depicted by FIG. 1A and the procedures described with respect to each functional component are provided for purposes of illustration only, and that embodiments of the invention are not necessarily limited to a particular functional or structural architecture; the various procedures discussed herein may be performed in any suitable framework.

In many cases, the system 100 of FIG. 1A may be operated by a fraud prevention service, security service, etc. (referred to herein as a “fraud prevention provider”) for one or more customers. Often, the customers will be entities with products, brands and/or web sites that risk being imitated, counterfeited and/or spoofed, such as online merchants, financial institutions, businesses, etc. In other cases, however, the fraud prevention provider may be an employee of the customer an/or an entity affiliated with and/or incorporated within the customer, such as the customer's security department, information services department, etc.

In accordance with some embodiments, of the invention, the system 100 can include (and/or have access to) a variety of data sources 105. Although the data sources 105 are depicted, for ease of illustration, as part of system 100, those skilled in the art will appreciate, based on the disclosure herein, that the data sources 105 often are maintained independently by third parties and/or may be accessed by the system 100. In some cases, certain of the data sources 105 may be mirrored and/or copied locally (as appropriate), e.g., for easier access by the system 100.

The data sources 105 can comprise any source from which data about a possible online fraud may be obtained, including, without limitation, one or more chat rooms 105a, newsgroup feeds 105b, domain registration files 105c, and/or email feeds 105d. The system 100 can use information obtained from any of the data sources 105 to detect an instance of online fraud and/or to enhance the efficiency and/or effectiveness of the fraud prevention methodology discussed herein. In some cases, the system 100 (and/or components thereof) can be configured to “crawl” (e.g., to automatically access and/or download information from) various of the data sources 105 to find pertinent information, perhaps on a scheduled basis (e.g., once every 10 minutes, once per day, once per week, etc.).

Merely by way of example, there are several newsgroups commonly used to discuss new scamming/spoofing schemes, as well as to trade lists of harvested email addresses. There are also anti-abuse newsgroups that track such schemes. The system 100 may be configured to crawl any applicable newsgroup(s) 105b to find information about new spoof scams, new lists of harvested addresses, new sources for harvested addresses, etc. In some cases, the system 100 may be configured to search for specified keywords (such as “phish,” “spoof,” etc.) in such crawling. In other cases, newsgroups may be scanned for URLs, which may be download (or copied) and subjected to further analysis, for instance, as described in detail below. In addition, as noted above, there may be one or more anti-abuse groups that can be monitored. Such anti-abuse newsgroups often list new scams that have been discovered and/or provide URLs for such scams. Thus, such anti-abuse groups may be monitored/crawled, e.g., in the way described above, to find relevant information, which may then be subjected to further analysis. Any other data source (including, for example, web pages and/or entire web sites, email messages, etc.) may be crawled and/or searched in a similar manner.

As another example, online chat rooms (including without limitation, Internet Relay Chat (“IRC”) channels, chat rooms maintained/hosted by various ISPs, such as Yahoo, America Online, etc., and/or the like) (e.g., 105a) may be monitored (and/or logs from such chat rooms may be crawled) for pertinent information. In some cases, an automated process (known in the art as a “bot”) may be used for this purpose. In other cases, however, a human attendant may monitor such chat rooms personally. Those skilled in the art will appreciate that often such chat rooms require participation to maintain access privileges. In some cases, therefore, either a bot or a human attendant may post entries to such chat rooms in order to be seen as a contributor.

Domain registration zone files 105c (and/or any other sources of domain and/or network information, such as Internet registry e.g., ARIN) may also be used as data sources. As those skilled in the art will appreciate, zone files are updated periodically (e.g., hourly or daily) to reflect new domain registrations. These files may be crawled/scanned periodically to look for new domain registrations. In particular embodiments, a zone file 105c may be scanned for registrations similar to a customer's name and/or domain. Merely by way of example, the system 100 can be configured to search for similar domains registration with a different top level domain (“TLD”) or global top level domain (“gTLD”), and/or a domains with similar spellings. Thus, if a customer uses the <acmeproducts.com> domain, the registration of <acmeproducts.biz>, <acmeproducts.co.uk>, and/or <acmeproduct.com> might be of interest as potential hosts for spoof sites, and domain registrations for such domains could be downloaded and/or noted, for further analysis of the domains to which the registrations correspond. In some embodiments, if a suspicious domain is found, that domain may be placed on a monitoring list. Domains on the monitoring list may be monitored periodically, as described in further detail below, to determine whether the domain has become “live” (e.g., whether there is an accessible web page associated with the domain).

One or more email feeds 105d can provide additional data sources for the system 100. An email feed can be any source of email messages, including spam messages, as described above. (Indeed, a single incoming email message may be considered an email feed in accordance with some embodiments.) In some cases, for instance as described in more detail below, bait email addresses may be “seeded” or planted by embodiments of the invention, and/or these planted addresses can provide a source of email (i.e., an email feed). The system 100, therefore, can include an address planter 170, which is shown in detail with respect to FIG. 1B.

The address planter 170 can include an email address generator 175. The address generator 175 can be in communication with a user interface 180 and/or one or more databases 185 (each of which may comprise a relational database and/or any other suitable storage mechanism). One such data store may comprises a database of userid information 185a. The userid information 185a can include a list of names, numbers and/or other identifiers that can be used to generate userids in accordance with embodiments of the invention. In some cases, the userid information 185a may be categorized (e.g., into first names, last names, modifiers, such as numbers or other characters, etc.). Another data store may comprise domain information 180. The database of domain information 180 may include a list of domains available for addresses. In many cases, these domains will be domains that are owned/managed by the operator of the address planter 170. In other cases, however, the domains might be managed by others, such as commercial and/or consumer ISPs, etc.

The address generator 175 comprises an address generation engine, which can be configured to generate (on an individual and/or batch basis), email addresses that can be planted at appropriate locations on the Internet (or elsewhere). Merely by way of example, the address generator 175 may be configured to select one or more elements of userid information from the userid data store 185a (and/or to combine a plurality of such elements), and append to those elements a domain selected from the domain data store 185b, thereby creating an email address. The procedure for combining these components is discretionary. Merely by way of example, in some embodiments, the address generator 175 can be configured to prioritize certain domain names, such that relatively more addresses will be generated for those domains. In other embodiments, the process might comprise a random selection of one or more address components.

Some embodiments of the address planter 170 include a tracking database 190, which can be used to track planting operations, including without limitation the location (e.g., web site, etc.) at which a particular address is planted, the date/time of the planting, as well as any other pertinent detail about the planting. Merely by way of example, if an address is planted by subscribing to a mailing list with a given address, the mailing list (as well, perhaps, as the web site, list maintainer's email address, etc.) can be documented in the tracking database. In some cases, the tracking of this information can be automated (e.g., if the address planter's 170 user interface 180 includes a web browser and/or email client, and that web browser/email client is used to plant the address, information about the planting information may be automatically registered by the address planter 170). Alternatively, a user may plant an address manually (e.g., using her own web browser, email client, etc.), and therefore may add pertinent information to the tracking database via a dedicated input window, web browser, etc.

In one set of embodiments, therefore, the address planter 170 may be used to generate an email address, plant an email address (whether or not generated by the address planter 170) in a specified location and/or track information about the planting operation. In particular embodiments, the address planter 170 may also include one or more application programming interfaces (“API”) 195, which can allow other components of the system 100 of FIG. 1 (or any other appropriate system) to interact programmatically with the address planter. Merely by way of example, in some embodiments, an API 195 can allow the address planter 170 to interface with a web browser, email client, etc. to perform planting operations. (In other embodiments, as described above, such functionality may be included in the address planter 170 itself).

A particular use of the API 195 in certain embodiments is to allow other system components (including, in particular, the event manager 135) to obtain and/or update information about address planting operations (and/or their results). (In some cases, programmatic access to the address planter 170 may not be needed—the necessary components of the system 100 can merely have access—via SQL, etc.—one or more of the data stores 185, as needed.) Merely by way of example, if an email message is analyzed by the system 100 (e.g., as described in detail below), the system 100 may interrogate the address planter 170 and/or one or more of the data stores 185 to determine whether the email message was addressed to an address planted by the address planter 170. If so, the address planter 170 (or some other component of the system 100, such as the event manager 135), may note the planting location as a location likely to provoke phish messages, so that additional addresses may be planted in such a location, as desired. In this way, the system 100 can implement a feedback loop to enhance the efficiency of planting operations. (Note that this feedback process can be implemented for any desired type of “unsolicited” message, including without limitation phish messages, generic spam messages, messages evidencing trademark misuse, etc.).

Other email feeds are described elsewhere herein, and they can include (but are not limited to), messages received directly from spammers/phishers; email forwarded from users, ISPs and/or any other source (based, perhaps, on a suspicion that the email is a spam and/or phish); email forwarded from mailing lists (including without limitation anti-abuse mailing lists), etc. When an email message (which might be a spam message) is received by the system 100, that message can be analyzed to determine whether it is part of a phishing/spoofing scheme. The analysis of information received from any of these data feeds is described in further detail below, and it often includes an evaluation of whether a web site (often referenced by a URL or other information received/downloaded from a data source 105) is likely to be engaged in a phishing and/or spoofing scam.

Any email message incoming to the system can be analyzed according to various methods of the invention. As those skilled in the art will appreciate, there is a vast quantity of unsolicited email traffic on the Internet, and many of those messages may be of interest in the online fraud context. Merely by way of example, some email messages may be transmitted as part of a phishing scam, described in more detail herein. Other messages may solicit customers for black- and/or grey-market goods, such as pirated software, counterfeit designer items (including without limitation watches, handbags, etc.). Still other messages may be advertisements for legitimate goods, but may comprise unlawful or otherwise forbidden (e.g., by contract) practices, such as improper trademark use and/or infringement, deliberate under-pricing of goods, etc. Various embodiments of the invention can be configured to search for, identify and/or respond to one or more of these practices, as detailed below. (It should be noted as well that certain embodiments may be configured to access, monitor, crawl, etc. data sources—including zone files, web sites, chat rooms, etc.—other than email feeds for similar conduct). Merely by way of example, the system 100 could be configured to scan one or more data sources for the term ROLEX, and/or identify any improper advertisements for ROLEX watches.

Those skilled in the art will further appreciate that an average email address will receive many unsolicited email messages, and the system 100 may be configured, as described below, to receive and/or analyze such messages. Incoming messages may be received in many ways. Merely by way of example, some messages might be received “randomly,” in that no action is taken to prompt the messages. Alternatively, one or more users may forward such messages to the system. Merely by way of example, an ISP might instruct its users to forward all unsolicited messages to a particular address, which could be monitored by the system 100, as described below, or might automatically forward copies of users' incoming messages to such an address. In particular embodiments, an ISP might forward suspicious messages transmitted to its users (and/or parts of such suspicious messages, including, for example, any URLs included in such messages) to the system 100 (and/or any appropriate component thereof) on a periodic basis. In some cases, the ISP might have a filtering system designed to facilitate this process, and/or certain features of the system 100 might be implemented (and/or duplicated) within the ISP's system.

As described above, the system 100 can also plant or “seed” bait email addresses (and/or other bait information) in certain of the data sources, e.g. for harvesting by spammers/phishers. In general, these bait email addresses are designed to offer an attractive target to a harvester of email addresses, and the bait email addresses usually (but not always) will be generated specifically for the purpose of attracting phishers and therefore will not be used for normal email correspondence.

Returning to FIG. 1A, therefore, the system 100 can further include a “honey pot” 110. The honey pot 110 can be used to receive information from each of the data sources 105 and/or to correlate that information for further analysis if needed. The honey pot 110 can receive such information in a variety of ways, according to various embodiments of the invention, and how the honey pot 110 receives the information is discretionary.

Merely by way of example, the honey pot 100 may, but need not, be used to do the actual crawling/monitoring of the data sources, as described above. (In some cases, one or more other computers/programs may be used to do the actual crawling/monitoring operations and/or may transmit to the honey pot 110 any relevant information obtained through such operations. For instance, a process might be configured to monitor zone files and transmit to the honey pot 110 for analysis any new, lapsed and/or otherwise modified domain registrations. Alternatively, a zone file can be fed as input to the honey pot 110, and/or the honey pot 110 can be used to search for any modified domain registrations.) The honey pot 110 may also be configured to receive email messages (which might be forwarded from another recipient) and/or to monitor one or more bait email addresses for incoming email. In particular embodiments, the system 100 may be configured such that the honey pot 110 is the mail server for one or more email addresses (which may be bait addresses), so that all mail addressed to such addresses is sent directly to the honey pot 110. The honey pot 110, therefore, can comprise a device and/or software that functions to receive email messages (such as an SMTP server, etc.) and/or retrieve email messages (such as a POP3 and/or IMAP client, etc.) addressed to the bait email addresses. Such devices and software are well-known in the art and need not be discussed in detail herein. In accordance with various embodiments, the honey pot 110 can be configured to receive any (or all) of a variety of well-known message formats, including SMTP, MIME, HTML, RTF, SMS and/or the like. The honey pot 110 may also comprise one or more databases (and/or other data structures), which can be used to hold/categorize information obtained from email messages and other data (such as zone files, etc.), as well as from crawling/monitoring operations.

In some aspects, the honey pot 110 might be configured to do some preliminary categorization and/or filtration of received data (including without limitation received email messages). In particular embodiments, for example, the honey pot 110 can be configured to search received data for “blacklisted” words or phrases. (The concept of a “blacklist” is described in further detail below). The honey pot 110 can segregate data/messages containing such blacklisted terms for prioritized processing, etc. and/or filter data/messages based on these or other criteria.

The honey pot 110 also may be configured to operate in accordance with a customer policy 115 . An exemplary customer policy might instruct the honey pot to watch for certain types and/or formats of emails, including, for instance, to search for certain keywords, allowing for customization on a customer-by-customer basis. In addition, the honey pot 110 may utilize extended monitoring options 120, including monitoring for other conditions, such as monitoring a customer's web site for compromises, etc. The honey pot 110, upon receiving a message, optionally can convert the email message into a data file.

In some embodiments, the honey pot 110 will be in communication with one or more correlation engines 125, which can perform a more detailed analysis of the email messages (and/or other information/data, such as information received from crawling/monitoring operations) received by the honey pot 110. (It should be noted, however, that the assignment of functions herein to various components, such as honey pots 110, correlation engines 125, etc. is arbitrary, and in accordance with some embodiments, certain components may embody the functionality ascribed to other components.)

On a periodic basis and/or as incoming messages/information are received/retrieved by the honey pot 110, the honey pot 110 will transmit the received/retrieved email messages (and/or corresponding data files) to an available correlation engine 125 for analysis. Alternatively, each correlation engine 125 may be configured to periodically retrieve messages/data files from the honey pot 110 (e.g., using a scheduled FTP process, etc.). For example, in certain implementations, the honey pot 110 may store email messages and/or other data (which may or may not be categorized/filtered), as described above, and each correlation engine may retrieve data an/or messages on a periodic and/or ad hoc basis. For instance, when a correlation engine 125 has available processing capacity (e.g., it has finished processing any data/messages in its queue), it might download the next one hundred messages, data files, etc. from the honeypot 110 for processing. In accordance with certain embodiments, various correlation engines (e.g., 125a, 125b, 125c, 125d) may be specifically configured to process certain types of data (e.g., domain registrations, email, etc.). In other embodiments, all correlation engines 125 may be configured to process any available data, and/or the plurality of correlation engines (e.g., 125a, 125b, 125c, 125d) can be implemented to take advantage of the enhanced efficiency of parallel processing.

The correlation engine(s) 125 can analyze the data (including, merely by way of example, email messages) to determine whether any of the messages received by the honey pot 110 are phish messages and/or are likely to evidence a fraudulent attempt to collect personal information. Procedures for performing this analysis are described in detail below.

The correlation engine 125 can be in communication an event manager 135, which may also be in communication with a monitoring center 130. (Alternatively, the correlation engine 125 may also be in direct communication with the monitoring center 130.) In particular embodiments, the event manager 135 may be a computer and/or software application, which can be accessible by a technician in the monitoring center 130. If the correlation engine 125 determines that a particular incoming email message is a likely candidate for fraudulent activity or that information obtained through crawling/monitoring operations may indicate fraudulent activity, the correlation engine 125 can signal to the event manager 135 that an event should be created for the email message. In particular embodiments, the correlation engine 125 and/or event manager 135 can be configured to communicate using the Simple Network Management (“SNMP”) protocol well known in the art, and the correlation engine's signal can comprise an SNMP “trap” indicating that analyzed message(s) and/or data have indicated a possible fraudulent event that should be investigated further. In response to the signal (e.g., SNMP trap), the event manager 135 can create an event (which may comprise an SNMP event or may be of a proprietary format).

Upon the creation of an event, the event manager 135 can commence an intelligence gathering operation (investigation) 140 of the message/information and/or any URLs included in and/or associated with message/information. As described in detail below, the investigation can include gathering information about the domain and/or IP address associated with the URLs, as well as interrogating the server(s) hosting the resources (e.g., web page, etc.) referenced by the URLs. (As used herein, the term “server” is sometimes used, as the context indicates, any computer system that is capable of offering IP-based services or conducting online transactions in which personal information may be exchanged, and specifically a computer system that may be engaged in the fraudulent collection of personal information, such as by serving web pages that request personal information. The most common example of such a server, therefore, is a web server that operates using the hypertext transfer protocol (“HTTP”) and/or any of several related services, although in some cases, servers may provide other services, such as database services, etc.). In certain embodiments, if a single email message (or information file) includes multiple URLs, a separate event may be created for each URL; in other cases, a single event may cover all of the URLs in a particular message. If the message and/or investigation indicates that the event relates to a particular customer, the event may be associated with that customer.

The event manager can also prepare an automated report 145 (and/or cause another process, such as a reporting module (not shown) to generate a report), which may be analyzed by an additional technician at the monitoring center 130 (or any other location, for that matter), for the event; the report can include a summary of the investigation and/or any information obtained by the investigation. In some embodiments, the process may be completely automated, so that no human analysis is necessary. If desired (and perhaps as indicated by the customer policy 115), the event manager 135 can automatically create a customer notification 150 informing the affected customer of the event. The customer notification 150 can comprise some (or all) of the information from the report 145. Alternatively, the customer notification 150 can merely notify the customer of an event (e.g., via email, telephone, pager, etc.) allowing a customer to access a copy of the report (e.g., via a web browser, client application, etc.). Customers may also view events of interest to the using a portal, such as a dedicated web site that shows events involving that customer (e.g., where the event involves a fraud using the customer's trademarks, products, business identity, etc.).

If the investigation 140 reveals that the server referenced by the URL is involved in a fraudulent attempt to collect personal information, the technician may initiate an interdiction response 155 (also referred to herein as a “technical response”). (Alternatively, the event manager 135 could be configured to initiate a response automatically without intervention by the technician). Depending on the circumstances and the embodiment, a variety of responses could be appropriate. For instance, those skilled in the art will recognize that in some cases, a server can be compromised (i.e., “hacked”), in which case the server is executing applications and/or providing services not under the control of the operator of the server. (As used in this context, the term “operator” means an entity that owns, maintains and/or otherwise is responsible for the server.) If the investigation 140 reveals that the server appears to be compromised, such that the operator of the server is merely an unwitting victim and not a participant in the fraudulent scheme, the appropriate response could simply comprise informing the operator of the server that the server has been compromised, and perhaps explaining how to repair any vulnerabilities that allowed the compromise.

In other cases, other responses may be more appropriate. Such responses can be classified generally as either administrative 160 or technical 165 in nature, as described more fully below. In some cases, the system 100 may include a dilution engine (not shown), which can be used to undertake technical responses, as described more fully below. In some embodiments, the dilution engine may be a software application running on a computer and configured, inter alia, to create and/or format responses to a phishing scam, in accordance with methods of the invention. The dilution engine may reside on the same computer as (and/or be incorporated in) a correlation engine 125, event manager 135, etc. and/or may reside on a separate computer, which may be in communication with any of these components.

As described above, in some embodiments, the system 100 may incorporate a feedback process, to facilitate a determination of which planting locations/techniques are relatively more effective at generating spam. Merely by way of example, the system 100 can include an address planter 170, which may provide a mechanism for tracking information about planted addresses, as described above. Correspondingly, the event manager 135 may be configured to analyze an email message (and particular, a message resulting in an event) to determine if the message resulted from a planting operation. For instance, the addressees of the message may be evaluated to determine which, if any, correspond to one or more address(es) planted by the system 100. If it is determined that the message does correspond to one or more planted addresses, a database of planted addresses may be consulted to determine the circumstances of the planting, and the system 100 might display this information for a technician. In this way, a technician could choose to plant additional addresses in fruitful locations. Alternatively, the system 100 could be configured to provide automatic feedback to the address planter 170, which in turn could be configured to automatically plant additional addresses in such locations.

In accordance with various embodiments of the invention, therefore, a set of data about a possible online fraud (which may be an email message, domain registration, URL, and/or any other relevant data about an online fraud) may be received and analyzed to determine the existence of a fraudulent activity, an example of which may be a phishing scheme. As used herein, the term “phishing” means a fraudulent scheme to induce a user to take an action that the user would not otherwise take, such as provide his or her personal information, buy illegitimate products, etc., often by sending unsolicited email message (or some other communication, such as a telephone call, web page, SMS message, etc.) requesting that the user access an server, such as a web server, which may appear to be legitimate. If so, any relevant email message, URL, web site, etc. may be investigated, and/or responsive action may be taken. Additional features and other embodiments are discussed in further detail below.

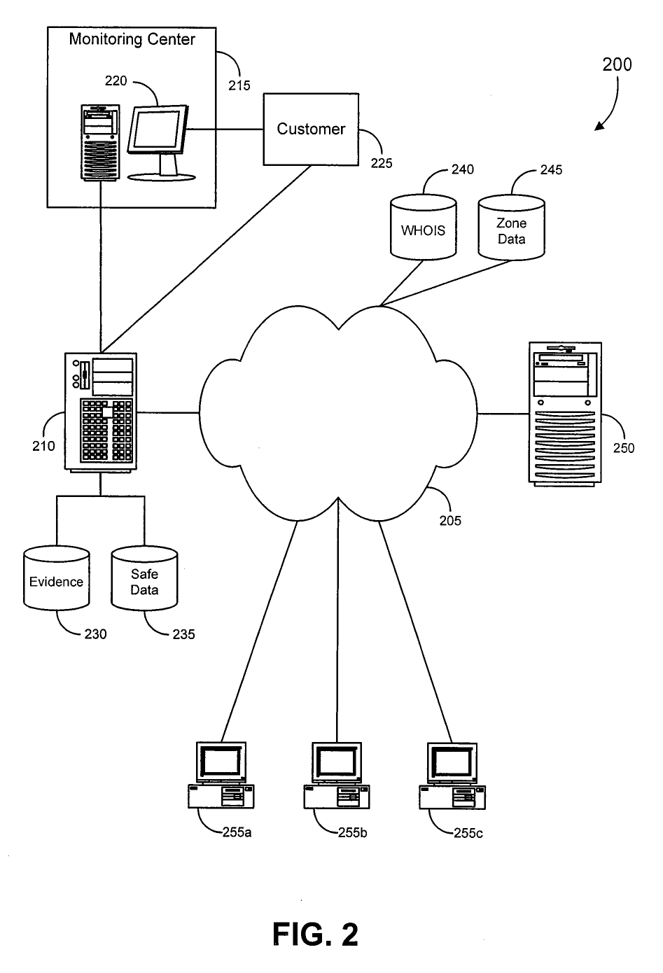

As noted above, certain embodiments of the invention provide systems for dealing with online fraud. The system 200 of FIG. 2 can be considered exemplary of one set of embodiments. The system 200 generally runs in a networked environment, which can include a network 205. In many cases, the network 205 will be the Internet, although in some embodiments, the network 205 may be some other public and/or private network. In general, any network capable of supporting data communications between computers will suffice. The system 200 includes a master computer 210, which can be used to perform any of the procedures or methods discussed herein. In particular, the master computer 210 can be configured (e.g., via a software application) to crawl/monitor various data sources, seed bait email addresses, gather and/or analyze email messages transmitted to the bait email addresses, create and/or track events, investigate URLs and/or servers, prepare reports about events, notify customers about events, and/or communicate with a monitoring center 215 (and, more particularly, with a monitoring computer 220 within the monitoring center) e.g. via a telecommunication link. The master computer 210 may be a plurality of computers, and each of the plurality of computers may be configured to perform specific processes in accordance with various embodiments. Merely by way of example, one computer may be configured to perform the functions described above with respect to a honey pot, another computer may be configured to execute software associated with a correlation engine, e.g. performing the analysis of email messages/data files; a third computer may be configured to serve as an event manager, e.g., investigating and/or responding to incidents of suspected fraud, and/or a fourth computer may be configured to act as a dilution engine, e.g., to generate and/or transmit a technical response, which may comprise, merely by way of example, one or more HTTP requests, as described in further detail below. Likewise, the monitoring computer 220 may be configured to perform any appropriate functions.

The monitoring center 215, the monitoring computer 220, and/or the master computer 210 may be in communication with one or more customers 225 e.g., via a telecommunication link, which can comprise connection via any medium capable of providing voice and/or data communication, such as a telephone line, wireless connection, wide area network, local area network, virtual private network, and/or the like. Such communications may be data communications and/or voice communications (e.g., a technician at the monitoring center can conduct telephone communications with a person at the customer). Communications with the customer(s) 225 can include transmission of an event report, notification of an event, and/or consultation with respect to responses to fraudulent activities.

The master computer 210 can include (and/or be in communication with) a plurality of data sources, including without limitation the data sources 105 described above. Other data sources may be used as well. For example, the master computer can comprise an evidence database 230 and/or a database of “safe data,” 235, which can be used to generate and/or store bait email addresses and/or personal information for one or more fictitious (or real) identities, for use as discussed in detail below. (As used herein, the term “database” should be interpreted broadly to include any means of storing data, including traditional database management software, operating system file systems, and/or the like.) The master computer 210 can also be in communication with one or more sources of information about the Internet and/or any servers to be investigated. Such sources of information can include a domain WHOIS database 240, zone data file 245, etc. Those skilled in the art will appreciate that WHOIS databases often are maintained by central registration authorities (e.g., the American Registry for Internet Numbers (“ARIN”), Network Solutions, Inc., etc), and the master computer 210 can be configured to query those authorities; alternatively, the master computer 210 could be configured to obtain such information from other sources, such as privately-maintained databases, etc. The master computer 210 (and/or any other appropriate system component) may use these resources, and others, such as publicly-available domain name server (DNS) data, routing data and/or the like, to investigate a server 250 suspected of conducting fraudulent activities. As noted above, the server 250 can be any computer capable of processing online transactions, serving web pages and/or otherwise collecting personal information.

The system can also include one or more response computers 255, which can be used to provide a technical response to fraudulent activities, as described in more detail below. In particular embodiments, one or more the response computers 255 may comprise and/or be in communication with a dilution engine, which can be used to create and/or format a response to a phishing scam. (It should be noted that the functions of the response computers 255 can also be performed by the master computer 210, monitoring computer 220, etc.) In particular embodiments, a plurality of computers (e.g., 255a-c) can be used to provide a distributed response. The response computers 255, as well as the master computer 210 and/or the monitoring computer 220, can be special-purpose computers with hardware, firmware and/or software instructions for performing the necessary tasks. Alternatively, these computers 210, 220, 255 may be general purpose computers having an operating system including, for example, personal computers and/or laptop computers running any appropriate flavor of Microsoft Corp.'s Windows and/or Apple Corp.'s Macintosh operating systems) and/or workstation computers running any of a variety of commercially-available UNIX or UNIX-like operating systems. In particular embodiments, the computers 210, 220, 255 can run any of a variety of free operating systems such as GNU/Linux, FreeBSD, etc.

The computers 210, 220, 255 can also run a variety of server applications, including HTTP servers, FTP servers, CGI servers, database servers, Java servers, and the like. These computers can be one or more general purpose computers capable of executing programs or scripts in response to requests from and/or interaction with other computers, including without limitation web applications. Such applications can be implemented as one or more scripts or programs written in any programming language, including merely by way of example, C, C++, Java, COBOL, or any scripting language, such as Perl, Python, or TCL, or any combination thereof. The computers 210, 220, 255 can also include database server software, including without limitation packages commercially available from Oracle, Microsoft, Sybase, IBM and the like, which can process requests from database clients running locally and/or on other computers. Merely by way of example, the master computer 210 can be an Intel processor-machine operating the GNU/Linux operating system and the PostgreSQL database engine, configured to run proprietary application software for performing tasks in accordance with embodiments of the invention.

In some embodiments, one or more computers 110 can create web pages dynamically as necessary for displaying investigation reports, etc. These web pages can serve as an interface between one computer (e.g., the master computer 210) and another (e.g., the monitoring computer 220). Alternatively, a computer (e.g., the master computer 210) may run a server application, while another (e.g., the monitoring computer 220) device can run a dedicated client application. The server application, therefore, can serve as an interface for the user device running the client application. Alternatively, certain of the computers may be configured as “thin clients” or terminals in communication with other computers.

The system 200 can include one or more data stores, which can comprise one or more hard drives, etc. and which can be used to store, for example, databases (e.g., 230, 235) The location of the data stores is discretionary: Merely by way of example, they can reside on a storage medium local to (and/or resident in) one or more of the computers. Alternatively, they can be remote from any or all of these devices, so long as they are in communication (e.g., via the network 205) with one or more of these. In some embodiments, the data stores can reside in a storage-area network (“SAN”) familiar to those skilled in the art. (Likewise, any necessary files for performing the functions attributed to the computers 210, 220, 255 can be stored a computer-readable storage medium local to and/or remote from the respective computer, as appropriate.)

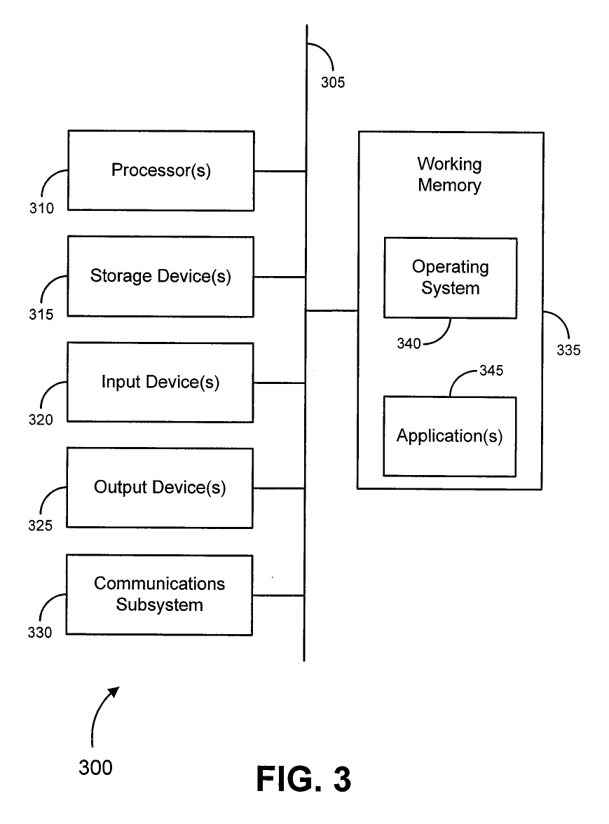

FIG. 3 provides a generalized schematic illustration of one embodiment of a computer system 300 that can perform the methods of the invention and/or the functions of a master computer, monitoring computer and/or response computer, as described herein. FIG. 3 is meant only to provide a generalized illustration of various components, any of which may be utilized as appropriate. The computer system 300 can include hardware components that can be coupled electrically via a bus 305, including one or more processors 310; one or more storage devices 315, which can include without limitation a disk drive, an optical storage device, solid-state storage device such as a random access memory (“RAM”) and/or a read-only memory (“ROM”), which can be programmable, flash-updateable and/or the like (and which can function as a data store, as described above). Also in communication with the bus 305 can be one or more input devices 320, which can include without limitation a mouse, a keyboard and/or the like; one or more output devices 325, which can include without limitation a display device, a printer and/or the like; and a communications subsystem 330; which can include without limitation a modem, a network card (wireless or wired), an infra-red communication device, and/or the like).

The computer system 300 also can comprise software elements, shown as being currently located within a working memory 335, including an operating system 340 and/or other code 345, such as an application program as described above and/or designed to implement methods of the invention. Those skilled in the art will appreciate that substantial variations may be made in accordance with specific embodiments and/or requirements. For example, customized hardware might also be used, and/or particular elements might be implemented in hardware, software (including portable software, such as applets), or both.

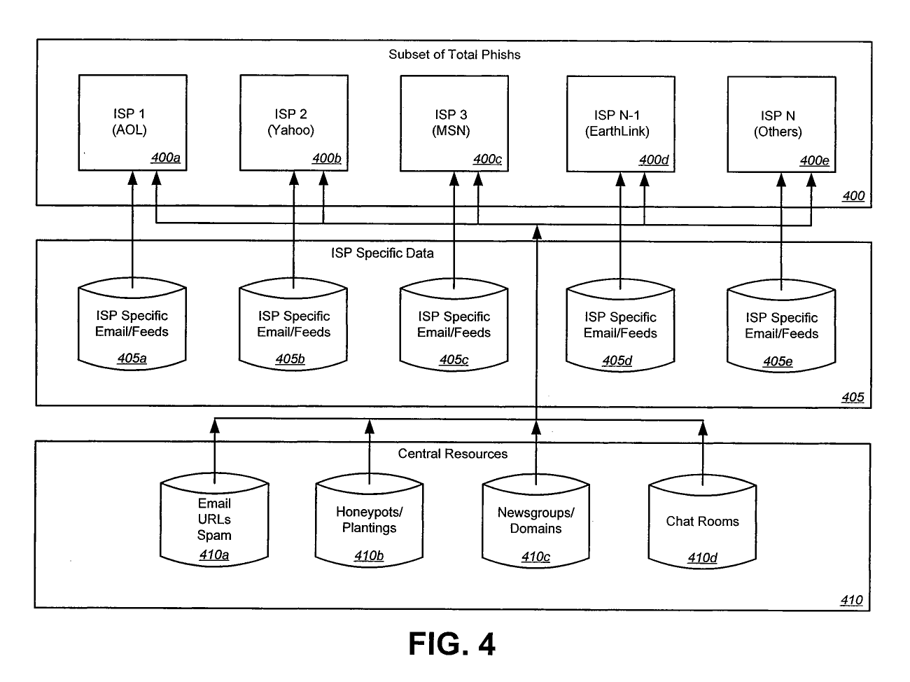

Generally, as illustrated by FIG. 4, a given ISP (or other business) 400 may receive data related to fraud from its own sources 405, as well as, perhaps, various data 410 from a security provider. In accordance with embodiments of the invention, a facility may be provided for the sharing of such data (and/or for the implementation of controls on how such sharing is performed, as described in more detail below).

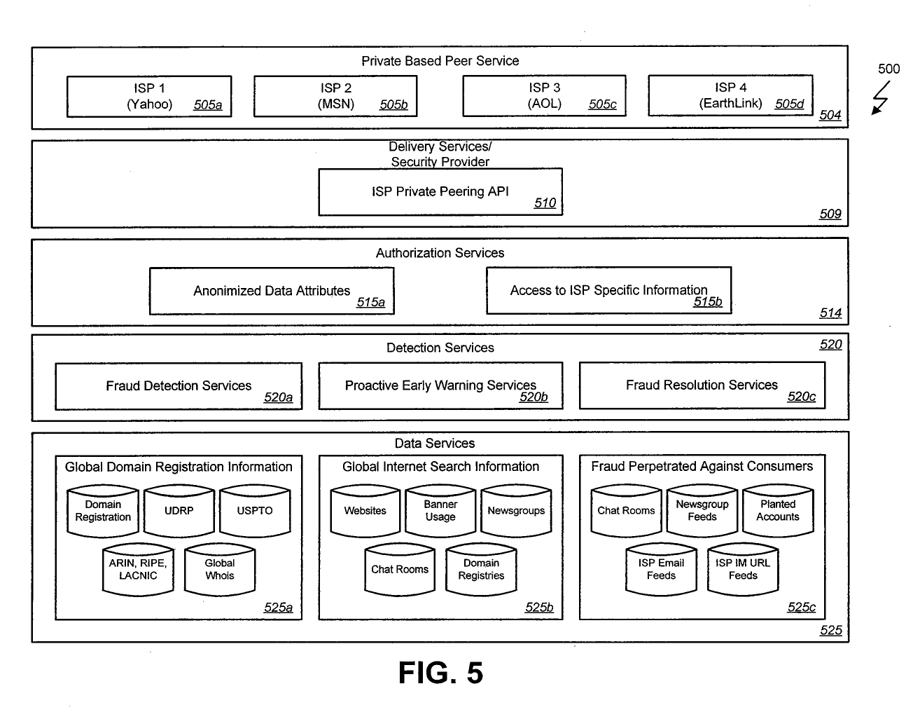

By way of example, FIG. 5 illustrates a system 500 in which a plurality of businesses 505 may participate in a peering relationship 504. In some cases, a security provider 509 will provide an application programming interface (“API”) 510 to allow for the interaction between the provider 509 and the businesses 505. The system may also provide other enhanced services, such as generating, analyzing and/or providing data attributes 515a related to various feeds, and or providing authorization services 514 or other control of access to information 515b specific to various businesses 505. Additional services 520 can include fraud detection services 520a, proactive early warning services 520b, and/or fraud response/resolution services 520c. Such services are described in detail in the Related Applications.

In some cases, the system may draw on a variety of data services 525 and/or sources (illustrated generally by the elements referenced by numerals 525a, 525b and 525c), many of which are described in the Related Applications.

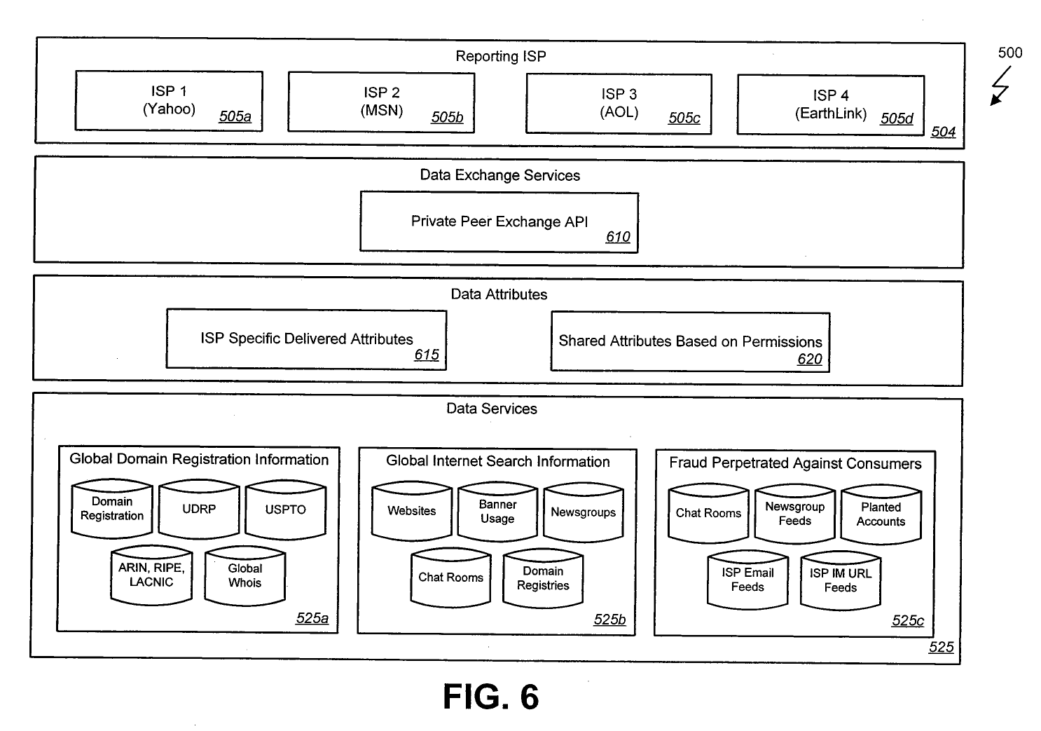

As illustrated by FIG. 6, the system 500 may also provide a private peer exchange API 610 (which may be the same API as the API 510 described above), to allow for the exchange of data between provider and the businesses 505, as well as, in some cases, between one business 505a and another 505b. Such information can include, without limitation, business-specific or entity specific delivered attributes 615 which may be specific to a particular business 505a and therefore, in some cases, not shared with other businesses 505b-d. Examples of such entity specific attributes can include, but are not limited to, information related to a fraud type, am original URL or port on which a communication was detected, a target entity of the fraud, data permissions, a reporter identifier, a reporter source, email data, etc. The data attributes may also include shared attributes 620, which may be shared between businesses or entities, based perhaps on permissions established by those businesses and/or the provider. Such permissions may be enforced by the API 610, to prevent the unauthorized access by one business 505a to data belonging to another business 505b. Some examples of shared data attributes 620 include but are not limited to ISP delivered attributes, a reporter reputation, a site status, a fraud identifier, a domain owner, network or ISP data, a report timestamp, a confirmation timestamp, etc. It should be noted that, in some cases, a business 505a may elect to share business-specific delivered attributes.

Embodiments of the invention may provide further additional features, including without limitation the provision for bilateral agreements (e.g., to share data attributes) between any two (or more businesses), based perhaps on negotiated conditions and/or data permissions. In some cases, the system may allow (e.g., through access control to various data attributes) for parties to gain from the system in proportion to the amount of data (e.g., feeds) they contribute to the system. The system can also support “anonymized” fraud detection, such that information from feeds can be genericized by the security provider (and/or by the system) before distribution to businesses, such that the private information of one business (and/or its customers) is not shared with other businesses, but the benefits of that business's data (and/or the analysis thereof) can be realized by others.

Reasons for exchanging such fraud and security related information can include, without limitaiton:
Discovering a new type or variation of a security event or threat when it is first launched, no matter where it is launched,
Understanding the breadth, duration and extent of any security event or threat,
Understanding the life cycle, lineage, adaptation and morphing over time of any security event or threat,
Building threat profiles (including histories, origins, permutations, models, classifications and samples) event logs, security data base, detection models and predictive capabilities,
Determining correlations, inter-relationships and differences between different security events or threats,
Understanding ones own experience with a security event or threat vs. others in the same or other industry, either individually or collectively,
Creating trends, data analysis, statistics and reports on security threats and events.

Various embodiments provide facilities, systems, programs, algorithms, processing, data storage, data transmission, processes, data definitions, schema, taxonomy, processes, workflows, and operations to enable ISPs, banks, auction service providers, security companies and others to deliver raw and/or processed security event or threat data (including without limitation feeds). The system then can process such data in a uniform way, and/or organize and/or store such raw and/or processed data according to defined and normalized definitions and standards, such that any one business will be able to define and negotiate bilaterally with any other business the specific types, amounts, volumes, times, forms and formats for the exact data they would like to exchange, and the commercial, operational and delivery terms they would like to apply to the data exchange.

Certain embodiments may be fairly lenient in allowing participants to submit (and/or retrieve) their own input data, so long as their data had some value and the participants adhered to certain standards related to the data integrity, format, definitions, delivery methods and reliability. The system, in some cases, will tag and/or track the input data's origins, ownership rights, source, direct and related party identities, reputations and use characteristics and limitations. The system then might process the data and/or develop additional derived data about the submitted data as well as correlate the data with other data we may have or other data submitted by others to create derived data. The data may also be stored over time, and/or multi-dimensional analysis may be performed, and relationships may be identified within specific data sets and across the entire data repository. Such analysis, and the identification of relationships, are described in more detail in the Related Applications.

Embodiments of the invention might also facilitate and enable bi-lateral or multi-lateral commercial agreements between participants such that they can negotiate what data they will exchange with others, as well as all the relevant commercial, technical and operational terms. The system, then, could then provide the service to fulfill this agreement, by providing to each party only the data and derived data they have agreed to exchange and that they have sufficient legal, commercial or other rights to have access to.

Hence, some embodiments encourage participants to submit all of their relevant fraud and security data, knowing that the will be able to define, control, benefit from and enforce (on a bilateral, multilateral, case-by-case and/or ad-hoc basis) who they will provide the data to, exactly what and how much of the data they will provide, what they will get in return (including monetary, exchange of data or services or other remuneration) and under what operational, technical, geographic, legal, regulatory, policy and commercial terms and limitations.

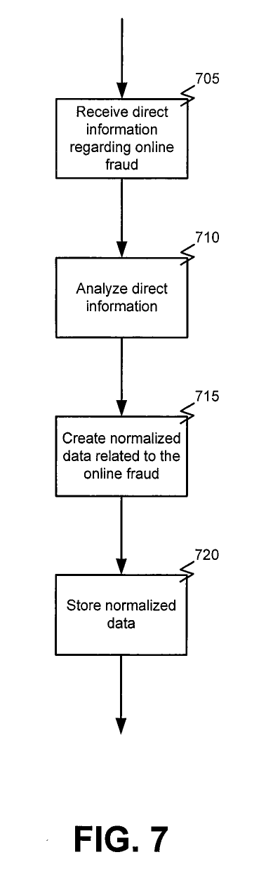

FIG. 7 is a flowchart illustrating a process for collecting information to provide enhanced fraud monitoring according to one embodiment of the present invention. In this example, the process begins with receiving 705 from a first entity direct information related to fraudulent online activity. As noted above, receiving the direct information from the first entity can comprise receiving the direct information via an Application Program Interface (API). Additional details of an exemplary API and data attributes of such an API will be discussed further below.

Once received 705, the direct information can be analyzed 710 and a set of normalized data related to the fraudulent online activity can be created 715. Analyzing 710 the direct information can comprise generating a set of derived information related to the fraudulent online activity. Generating the set of derived information related to the fraudulent online activity can be based on the direct information and previously saved information related to other fraudulent online activity. Such saved information can comprise direct information and derived information. The set of normalized data can be in a form readable by a plurality of entities and can include the direct information and the derived information. The set of normalized data can be stored 720.

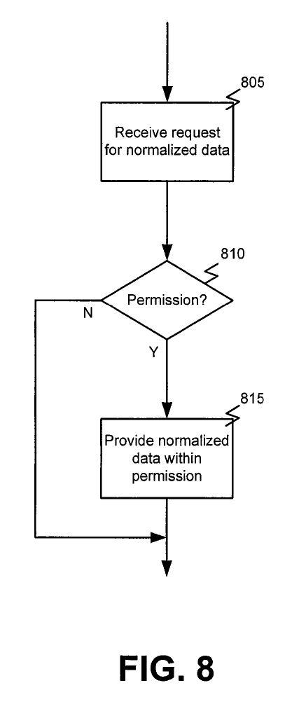

FIG. 8 is a flowchart illustrating a process for providing information related to enhanced fraud monitoring according to one embodiment of the present invention. In this example, the process begins with receiving 805 from a second entity of the plurality of entities a request to access the stored normalized data. As noted above, receiving the request to access the stored normalized data can comprise receiving the request via the API. Access to the stored normalized data by the second entity can be controlled 810. For example, as discussed above, controlling access to the stored normalized data by the second entity can be based on an agreement between the first entity and the second entity. If 810 permitted, at least a portion of the stored normalized data can be provided 815 to the second entity.

In a set of embodiments, the system may feature one or more APIs, including without limitation those described above. This API may be used in conjunction with an XML schema for the data, which defines how data should be submitted to and/or received from the system. The system may also include various measures for access control, authentication and/or transmission security (including without limitation various encryption and/or authentication schemes known in the art), both to protect information from illegitimate access (e.g., by hackers) and to prevent the unauthorized access by one participating business of another business's data. Optionally, data stored within the system may be encrypted, for instance to accommodate received data that contains some level of private or identity data that a participating business may need to protect for privacy or policy reasons.

In fact, in some cases, some or all of the data may reside at a participating business's location, depending on privacy laws and policies. In such cases, the system might serve as an intermediary between two (or more businesses), e.g., providing exchange management processing and/or instructions, but the data might be transmitted directly from participating business to participating business. (For example, a particular business, such as an ISP or a bank, might have more rights to use customer data for security purposes than a security provider has.

The following table lists a few examples various types of data attributes that may be received, processed, analyzed and/or provided by the system. Based on the disclosure herein, one skilled in the art will appreciate that other types of data may be used as well.

| Analyzed Item | Input Source | Input Source Creator |
|---|---|---|
| Domain Name | Zone file diff (EWS) | |
| | Brand harvesting | Search engine |
| Text | ISP | Spam collector |
| | | Honey pot |
| | | User submissions |
| | Customer | Spam |
| | | Honey pot |
| | | User submissions |
| | Planting | Planter |
| | | Planting address |
| | | Planting tool + version |
| URL | ISP Feed | Spam |
| | | Honey pot |
| | | User submissions |
| | IM Analysis | |
| | Email analysis | |
| | Graphics analysis | |
| | PopUp analysis | |
| | Manual entry | |
| | Auction site analysis | |
| IP address | ISP Feed | |
| | IM Analysis | |
| | Email analysis | |
| | Graphics analysis | |
| | PopUp Analysis | |
| | Manual entry | |
| | Web analysis | |
| | Auction site analysis | |
| Email address | Feed | ISP |
| | | Customer |
| | Email analysis | |
| | Web page analysis | |
| | IM analysis | |
| | Graphics correlation | |
| | Popup | |
| | Manual entry | |
| Logo | Email analysis | Text analysis |
| | | Logo analysis |
| | | Encryption (stego) analysis |
| | Web analysis | |
| | Popup analysis | |
| | Auction site analysis | |
| | Feed | |
| | Manual entry | |
| Picture/graphic | | |
| Registration record | Domain WhoIs | |
| | Network WhoIs | |
| Transaction | | |

The following table lists examples of types of metadata that may be used to tag and/or track sets of data received, processed, analyzed and/or provided by the system. Based on the disclosure herein, one skilled in the art will appreciate that other types of metadata may be used as well.

| | Input Source | |
|---|---|---|
| Identifier | Reputation | Derived Data |
| Timestamp | High Probability | Domain registry |
| Item ID | Suspicious | Registrar |
| Source ID | Low Probability | Name servers(s) |
| Customer ID | Confirmed | Network registry |
| Run date | | Access network |
| System ID | | IP block owner |
| | | Domain WhoIs |
| | | record (need whois |
| | | schema) |
| | | Network WhoIS |
| | | Record (need whois |
| | | schema) |

The following table lists examples of types of tags that may be used to identify various types of illegitimate activities associated with data received, processed, analyzed and/or provided by the system. Based on the disclosure herein, one skilled in the art will appreciate that other types of tags may be used as well.

| Rights Basis | Authority |
|---|---|
| Trademark | Statute |
| | Jurisdiction |
| | Country |
| | Treaty |
| | <New> |
| Copyright | Statute |
| | Jurisdiction |
| | Country |
| | Treaty |
| | <New> |
| Patent | Statute |
| | Jurisdiction |
| | Country |
| | Treaty |
| | <New> |
| Common Law | Precedent/Right |
| Right | Jurisdiction |
| | Country |
| | Treaty |
| | <New> |

While the private fraud peering model described herein is described with respect to the collection, processing and exchange of fraud and other security related data, the same model can be applied to the exchange of different types of data in other industries and for other purposes.

In the foregoing description, for the purposes of illustration, methods were described in a particular order. It should be appreciated that in alternate embodiments, the methods may be performed in a different order than that described. Additionally, the methods may contain additional or fewer steps than described above. It should also be appreciated that the methods described above may be performed by hardware components or may be embodied in sequences of machine-executable instructions, which may be used to cause a machine, such as a general-purpose or special-purpose processor or logic circuits programmed with the instructions, to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for providing enhanced fraud monitoring, the method comprising:
receiving from a first entity direct information related to fraudulent online activity;
analyzing the direct information;
creating a set of normalized data related to the fraudulent online activity, wherein the set of normalized data is in a form readable by a plurality of entities; and
storing the set of normalized data.

2. The method of claim 1, wherein analyzing the direct information comprises generating a set of derived information related to the fraudulent online activity.

3. The method of claim 2, wherein generating the set of derived information related to the fraudulent online activity is based on the direct information and previously saved information related to other fraudulent online activity.

4. The method of claim 3, wherein the saved information comprises direct information and derived information.

5. The method of claim 2, wherein the set of normalized data includes the direct information and the derived information.

6. The method of claim 1, further comprising:
receiving from a second entity of the plurality of entities a request to access the stored normalized data; and
controlling access to the stored normalized data by the second entity.

7. The method of claim 6, wherein controlling access to the stored normalized data by the second entity is based on an agreement between the first entity and the second entity.

8. The method of claim 6, further comprising providing at least a portion of the stored normalized data to the second entity.

9. The method of claim 6, wherein receiving the direct information from the first entity comprises receiving the direct information via an Application Program Interface (API).

10. The method of claim 9, wherein receiving the request to access the stored normalized data comprises receiving the request via the API.

11. The method of claim 10, wherein the stored normalized data is maintained by the first entity and the API provides finctions for the second entity to request the stored normalized data from the first entity.

12. The method of claim 10, wherein the stored normalized data is maintained by a security service and the API provides functions for the first entity to provide the direct information to the security service and for the second entity to request the stored normalized data from the security service.

13. The method of claim 10, wherein the API provides for receiving the direct information, analyzing the direct information, creating the set of normalized data, and accessing the stored normalized data through a plurality of data attributes.

14. The method of claim 13, wherein the data attributes comprise entity specific attributes specific to either the first entity or the second entity.

15. The method of claim 13, wherein the data attributes comprise shared attributes that can be shared between the first entity and the second entity based on permissions established by the first entity and the second entity.

16. The method of claim 13, wherein the API further comprises a schema defining the data attributes.

17. The method of claim 16, wherein the schema comprises an extensible Markup Language (XML) schema.

18. The method of claim 16, wherein the schema further comprises metadata tagged to the data attributes.

19. The method of claim 18, wherein the metadata tracks the data attributes to which it is tagged.

20. A machine-readable medium having stored thereon a series of instructions that, when executed by a processor, cause the processor to provide enhanced fraud monitoring by:
receiving from a first entity direct information related to fraudulent online activity;
analyzing the direct information;
creating a set of normalized data related to the fraudulent online activity, wherein the set of normalized data is in a form readable by a plurality of entities; and
storing the set of normalized data.

21. The machine-readable medium of claim 20, further comprising:
receiving from a second entity of the plurality of entities a request to access the stored normalized data; and
controlling access to the stored normalized data by the second entity.

22. The machine-readable medium of claim 21, wherein controlling access to the stored normalized data by the second entity is based on an agreement between the first entity and the second entity.

23. The machine-readable medium of claim 21, further comprising providing at least a portion of the stored normalized data to the second entity.

24. The machine-readable medium of claim 21, wherein receiving the direct information from the first entity comprises receiving the direct information via an Application Program Interface (API).

25. The machine-readable medium of claim 20, wherein receiving the request to access the stored normalized data comprises receiving the request via the API.

26. The machine-readable medium of claim 25, wherein the stored normalized data is maintained by the first entity and the API provides functions for the second entity to request the stored normalized data from the first entity.

27. The machine-readable medium of claim 25, wherein the stored normalized data is maintained by a security service and the API provides functions for the first entity to provide the direct information to the security service and for the second entity to request the stored normalized data from the security service.

28. The machine-readable medium of claim 25, wherein the API provides for receiving the direct information, analyzing the direct information, creating the set of normalized data, and accessing the stored normalized data through a plurality of data attributes.

29. The machine-readable medium of claim 28, wherein the data attributes comprise entity specific attributes specific to either the first entity or the second entity.

30. The machine-readable medium of claim 28, wherein the data attributes comprise shared attributes that can be shared between the first entity and the second entity based on permissions established by the first entity and the second entity.

31. A system for providing enhanced fraud monitoring, the system comprising:
a communication network;
a first client communicatively coupled with the communication network and adapted to provide direct information related to fraudulent online activity; and
a server communicatively coupled with the communication network and adapted to receive from the first client direct information related to fraudulent online activity, analyze the direct information, create a set of normalized data related to the fraudulent online activity, wherein the set of normalized data is in a form readable by a plurality of clients, and store the set of normalized data.

32. The system of claim 31, wherein the server is further adapted to generate a set of derived information related to the fraudulent online activity.

33. The system of claim 32, wherein the server is adapted to generate the set of derived information related to the fraudulent online activity based on the direct information and previously saved information related to other fraudulent online activity.

34. The system of claim 33, wherein the saved information comprises direct information and derived information.

35. The system of claim 32, wherein the set of normalized data includes the direct information and the derived information.

36. The system of claim 31, further comprising a second client and wherein the server is further adapted to receive from the second client a request to access the stored normalized data and control access to the stored normalized data by the second client.

37. The system of claim 36, wherein the server is adapted to control access to the stored normalized data by the second client based on an agreement between the first client and the second client.

38. The system of claim 36, wherein the server is further adapted to provide at least a portion of the stored normalized data to the second client.

39. The system of claim 36, wherein the server is adapted to receive the direct information from the first client via an Application Program Interface (API).

40. The system of claim 39, wherein the server receives the request to access the stored normalized data via the API.

41. The system of claim 40, wherein the API provides for receiving the direct information, analyzing the direct information, creating the set of normalized data, and accessing the stored normalized data through a plurality of data attributes.

42. The system of claim 41, wherein the data attributes comprise entity specific attributes specific to either the first client or the second client.

43. The system of claim 41, wherein the data attributes comprise shared attributes that can be shared between the first client and the second client based on permissions established by the first client and the second client.

44. A system for providing enhanced fraud monitoring, the system comprising:
a communication network;
a first client communicatively coupled with the communication network and adapted to generate direct information related to fraudulent online activity, analyze the direct information, create a set of normalized data related to the fraudulent online activity, wherein the set of normalized data is in a form readable by a plurality of clients, and store the set of normalized data;
a second client communicatively coupled with the communication network and adapted to request to access stored the stored normalized data;
a server communicatively coupled with the communication network and adapted to receive from the second a request to access the stored normalized data and control access to the stored normalized data by the second client.

45. The system of claim 44, wherein the server is adapted to control access to the stored normalized data by the second client based on an agreement between the first client and the second client.

46. The system of claim 44, wherein the first client is further adapted to provide at least a portion of the stored normalized data to the second client.

47. The system of claim 44, wherein the server is adapted to receive the request to access the stored normalized data from the second client by receiving the request via an Application Program Interface (API).

48. The system of claim 47, wherein the API provides for accessing the stored normalized data through a plurality of data attributes.

49. The system of claim 48, wherein the data attributes comprise client specific attributes specific to either the first client or the second client.

50. The system of claim 48, wherein the data attributes comprise shared attributes that can be shared between the first client and the second client based on permissions established by the first client and the second client.
